(19) United States
(12) Patent Application Publication
(10) Pub. No.: US 2007/0033096 A1
(43) Pub. Date: Feb. 8, 2007

(54) METHOD AND SYSTEM FOR ALLOCATING ADVERTISING BUDGET TO MEDIA IN ONLINE ADVERTISING

(75) Inventor: Ie Kyu Jeong, Seoul (KR)

Correspondence Address: BEYER WEAVER & THOMAS, LLP, P.O. BOX 70250, OAKLAND, CA, 94612-0250, US

(73) Assignee: CROSS MEDIA CO., INC.

(21) Appl. No.: 11/459,838

(22) Filed: Jul. 25, 2006

(30) Foreign Application Priority Data
Aug. 5, 2005 (KR) 10-2005-0071757

(51) Int. Cl. G07G 1/00

(52) U.S. Cl. 705/10

(57) ABSTRACT

Disclosed herein is a method and system for allocating advertising budget to media in online advertising. The method provides an optimal media mix through selection and combination of media in order of high media reach estimates for respective budget allocation units based on the number of media for which budget will be executed. With the method, the media mix to optimize media effects of advertisement campaign can be simply deduced, thereby maximizing a return on investment (ROI) of a client.

### BACKGROUND OF THE INVENTION

1. Field of the Invention

The present invention relates to a method and system for allocating advertising budget to media in online advertising. More particularly, the present invention relates to a method and system for allocating advertising budget to media in online advertising, which can provide an optimal media mix through selection and combination of media in order of high media reach estimates for respective budget allocation units in every case of the number of media for which a budget will be executed.

2. Description of the Related Art

If a client wants to forecast how many people will watch his or her TV commercial, a sample date for the number of unique viewers obtained by panel-based audience measurement is generally used for forecast of the result. However, the forecast through such panel-based audience measurement causes a serious error in the number of unique viewers, lowering reliability of the data.

For online advertising, since an advertising management system is mainly used to count and record whole data of media effects, including the number of requests for a banner page of publisher's site by the unique audience, the number of clicks for the banner page, etc., it is possible to report an accurate media effect, such as a media reach and a click per reach (CPR). As such, the media effect of current online advertising can be more accurately forecasted, on the basis of the whole data of media effects related to previous online advertising, than that of TV advertising.

In view of forecasting the media effect according to a budget, however, the online advertising also has problems as follows.

First, an increase of 10% in advertising budget cannot ensure an increase of 10% in media effect.

This is attributed to the fact that results of budget execution can be changed depending on various factors, such as clients, properties of campaigns, brands, advertising targets, viewers, etc. In addition, tendencies of diminishing marginal utility of respective online advertising media make it difficult to forecast the media effect according to the budget.

Secondly, unlike offline advertising, a scientific solution has not yet been developed in the art, which can provide an optimal media mix that maximizes the media effect of online advertising so as to maximize a return on investment (ROI) of a client. Currently, the media mix to maximize the media effects is provided according to individual experiences.

### SUMMARY OF THE INVENTION

The present invention has been made to solve the above problems, and it is an object of the present invention to provide a method of deducing media effect estimation functions for respective media.

It is another object of the invention to provide a method of searching an optimal media mix which can provide the maximum media effect with a predetermined advertising budget.

Additional objects and/or advantages of the invention will be apparent to persons having ordinary knowledge in the art from the drawing, the description, and claims.

In accordance with one aspect of the present invention, the above and other objects can be accomplished by the provision of a method for allocating advertising budget to media in online advertising, comprising the steps of: deducing media effect estimation functions of the respective media; calculating media effect estimates of the respective media according to budget allocation units from the media effect estimation functions; selecting the media in order of high media effect estimates with the respective budget allocation units in every case of the number of media desired to be executed with a budget by using the calculated media effect estimates of the media, followed by mixing the selected media to provide media mixes; summing up the total media effect estimates of the selected media for the respective media mixes obtained in the media selecting and mixing step; and selecting and suggesting a media mix providing a maximum summed-up media effect estimate among the summed-up media effect estimates obtained by the summing-up step.

The media effect comprises two effects, a reach effect and a response effect. The term “reach effect” means the number of unique viewers excluding the number of overlapped impressions upon execution of a specific budget, and the terms “response effect” means the number of clicks on an advertising banner for a given period of campaigning according to execution budget.

The media effect estimation functions may be deduced from a result obtained by filtering a database of existing advertising results accumulated for the respective media. If the media effect is the reach effect, the estimation functions may be deduced through analysis of items of media, budget, impression, and the number of unique viewers. Meanwhile, if the media effect is the response effect, the estimation functions may be deduced through analysis of items of media, budget, impression, and the number of clicks.

In accordance with another aspect of the present invention, a system of allocating advertising budget to media in online advertising, comprises: a means for deducing media effect estimation functions of the respective media; a means for calculating media effect estimates of the respective media according to budget allocation units from the media effect estimation functions; a means for selecting the media in order of high media effect estimates with the respective budget allocation units in every case of the number of media desired to be executed with a budget by using the calculated media effect estimates of the media, and for mixing the selected media to provide media mixes; a means for summing up the total media effect estimates of the selected media for the respective media mixes; and a means for selecting and suggesting a media mix providing a maximum summed-up media effect estimate among the summed-up media effect estimates.

### BRIEF DESCRIPTION OF THE DRAWINGS

The foregoing and other objects and features of the present invention will be more clearly understood from the following detailed description taken in conjunction with the accompanying drawings, in which:

FIG. 1 is a block diagram illustrating a process of allocating advertising budget to media according to the present invention, which can maximize online media effect.

FIG. 2 is a graph based on a reach effect estimation function deduced on the basis of data shown in Table 2.

FIG. 3 is a block diagram illustrating operation of an advertising budget allocation system according to the present invention.

### DESCRIPTION OF THE PREFERRED EMBODIMENTS

Preferred embodiments of the present invention will be described in detail with reference to the accompanying drawings in order to allow a person of ordinary knowledge in the art to practice the present invention easily.

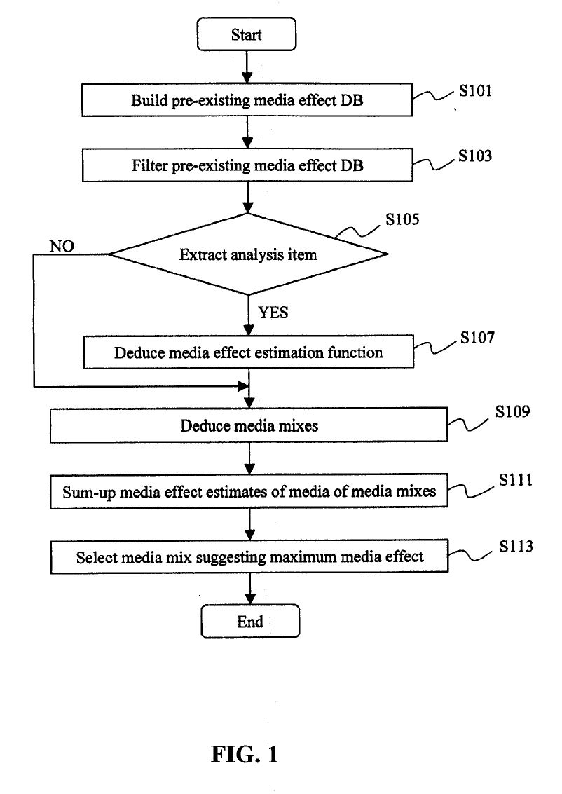

FIG. 1 is a block diagram illustrating a process of allocating advertising budget to media in accordance with the present invention, which can maximize online media effect.

First, a pre-existing media effect database recording pre-existing media effects of respective media is built (S101). After filtering the pre-existing media effect database of the respective media stored in an advertisement server (S103), media effect estimation functions of the respective media to forecast a reach effect and a response effect according to an advertising budget are deduced.

Herein, the term “media” means media which sell banner advertisements in Internet advertising, that is, Internet sites. Herein, the media generally refers to various Internet sites, for example, portal sites such as Yahoo, game sites, etc., which sell the banner advertisements irrespective of their main characteristics.

Herein, the term “reach effect” means the number of unique viewers of an associated banner advertisement according to a predetermined advertising budget. For example, if the banner advertisement is provided for 5 million advertisement impressions on the opening screen of A Company's site and the number of unique viewers for the banner advertisement is 3 million, it can be concluded that the remaining 2 million advertisement impressions are overlapped with the 3 million unique viewers. In the case where an advertising budget of $5,000 is allocated separately to A Company and B Company, if A Company ensures a banner advertisement of 5 million impressions and 3 million unique viewers, and if B Company ensures a banner advertisement of 4 million impressions and 3.5 million unique viewers, it can be concluded that the reach effect of B Company is greater than that of A Company with the same advertising budget. In other words, it can be understood that, as the number of unique viewers is increased within the same advertising budget, the reach effect of the advertisement is increased irrespective of the advertisement impressions.

The term “response effect” means the number of clicks on an impressed banner advertisement. For example, in the case where an advertising budget of $5,000 is allocated separately to A Company and B Company, if A Company ensures a banner advertisement of 5 million impressions and 50 thousand clicks, and if B Company ensures a banner advertisement of 4 million impressions and 60 thousand clicks, it can be concluded that the response effect of B Company is greater than that of A Company with the same advertising budget. In other words, it can be understood that, as the number of clicks is increased within the same advertising budget, the advertisement response effect is increased.

Table 1 shows an example of a pre-existing media effect database of A Company, for example, Yahoo.

TABLE 1

| | | Campaign | | | Unique | Average |
|---|---|---|---|---|---|---|
| Media | Advertiser | Titles | Budget | Impressions | Viewer | Frequency |
| Yahoo | C1 | Ab_May | $2,000 | 852,974 | 720,596 | 1.1 |
| Yahoo | C1 | Mnp_May | $5,000 | 6,375,610 | 3,356,843 | 1.8 |
| Yahoo | C2 | Cd_New | $5,000 | 5,131,449 | 3,348,451 | 1.5 |
| Yahoo | C1 | Mp3_June | $7,000 | 6,123,485 | 2,322,885 | 2.6 |
| Yahoo | C3 | Event_July | $10,000 | 11,554,742 | 5,430,472 | 2.1 |
| Yahoo | C4 | Ef_June | $10,000 | 9,297,442 | 3,823,879 | 2.4 |
| Yahoo | C4 | Gh_July | $10,000 | 12,165,725 | 4,638,147 | 2.6 |
| Yahoo | C5 | Ij_Apr | $10,000 | 28,192,837 | 9,070,466 | 3.1 |
| Yahoo | C5 | Kl_Mar | $10,000 | 35,131,897 | 10,439,852 | 3.3 |
| Yahoo | C6 | Mn_Jan | $10,000 | 12,997,529 | 5,995,663 | 2.1 |
| Yahoo | C6 | Op_Feb | $10,000 | 13,004,047 | 5,544,524 | 2.3 |
| Yahoo | C6 | Qr_Mar | $10,000 | 8,983,759 | 4,003,708 | 2.2 |
| Yahoo | C7 | St_Apr | $20,000 | 23,587,552 | 7,736,032 | 3 |

Next, the pre-existing media effect database is filtered to remove uncontrollable variables in prediction of execution results (S103).

First, after classifying the advertisement execution results according to the media, advertisement campaigns not corresponding to a predetermined budget allocation unit for media are removed. If the minimum budget allocation unit for the media is defined as $5,000, and an additional allocation budget is provided as multiples thereof, the advertisement campaigns corresponding to budget allocation units of $2,000 and $7,000 are removed from analysis.

In addition, if the number of unique viewers provided as the reach effects according to the respective budget allocation units exceeds a predetermined level, advertisement campaigns within, for example, upper and lower ranges of 10% are removed.

In the case where the budget allocation unit is $10,000 in Table 1, advertisement campaigns, the number of the unique viewers of which significantly deviates from an average level, that is, Ef_June of C4, Ij_April of C5, and Kl_March of C6, are removed. In view of statistical data, higher impressions result in an increase in the number of unique viewers. In this regard, if the impressions are excessively high or low with the same budget, and thus cause an excessively high or low number of unique viewers, forecasting the media effects of the respective media can be significantly deteriorated in accuracy. Thus, such a case is removed.

In addition, since the advertisement campaigns for long term contract clients are provided by service impressions of an average frequency or more, and have no relation to advertising budget allocation to the media for short-term advertisement campaigns, such advertisement campaigns for long term contract clients are precluded from analysis objects.

In addition, when the budget execution for a certain advertisement campaign is stopped due to personal situation of a client during the advertisement campaigns, such an advertisement campaign is also precluded from the analysis objects.

Text advertising or moving image advertising is also precluded from the analysis objects.

In order to deduce reach effect estimation functions from the database filtered in the step of S103, necessary analysis items are extracted from the database (S105). Specifically, in order to deduce the reach effect estimation functions of the media according to the budget, items of media, budget, impressions, and the number of unique viewers are extracted from several items in Table 1.

Table 2 shows results obtained through filtering and extraction of analysis items for A Company, for example, Yahoo.

TABLE 2

| | | | Unique |
|---|---|---|---|
| Media | Budget | Impressions | Viewer |
| Yahoo | $5,000 | 6,375,610 | 3,356,843 |
| | $5,000 | 5,131,449 | 3,348,451 |
| | $10,000 | 11,554,742 | 5,430,472 |
| | $10,000 | 12,165,725 | 4,638,147 |
| | $10,000 | 12,997,529 | 5,995,663 |
| | $10,000 | 13,004,047 | 5,544,524 |
| | $20,000 | 23,587,552 | 7,736,032 |

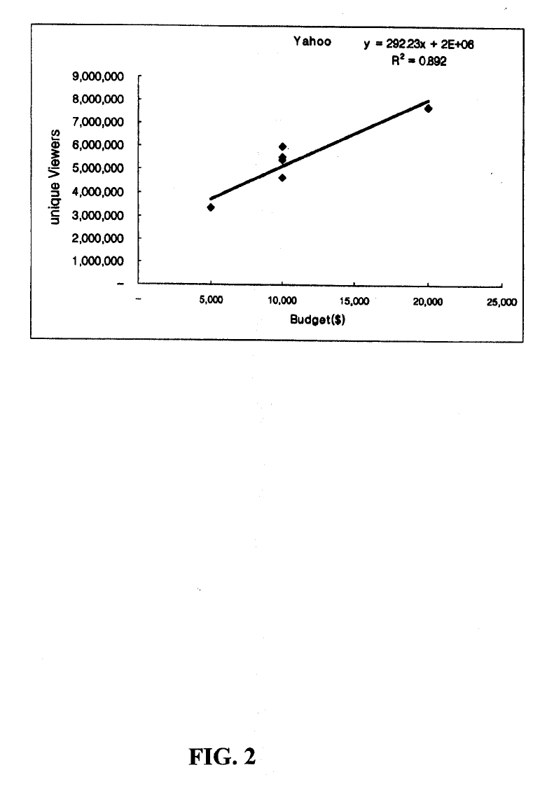

With a database obtained through filtering and extraction of the analysis items as shown in FIG. 2, a reach effect estimation function for A Company, for example, Yahoo is deduced by displaying the results on an xy-plane with the x-axis representing budget allocation units and the y-axis representing the number of unique viewers (S107). The budget allocation increases in units of $5,000 from the lowest value of $5,000. An upper limit of executable budget is determined in relation to the size of each medium. With the same method, a reach effect estimation function of another medium is deduced. Empirically, the estimation function is plotted in the form of a quadratic function or a logarithmic function. FIG. 2 is a graph depicted according to a reach effect estimation function deduced on the basis of data shown in Table 2.

It can be understood by those skilled in the art that forecasting of response effects of the media can be accomplished by the same method comprising the filtering step S103, the analysis item extracting step S105, and the reach effect estimation function deducing step S107 for forecasting the reach effects of the media as described above. In this regard, by using the number of clicks instead of the number of unique viewers used when building the reach effect estimation functions of the media, response effect estimation functions of the media can be deduced, and be used to estimate an expected number of clicks on respective media sites according to a budget.

Referring to FIG. 1 again, on the basis of the media effect estimation functions of the respective media obtained in the media effect estimation function deducing step S107 of FIG. 1, media effect estimates of the respective media according to budget allocation units are calculated, and an optimal media mix is deduced in such a way of selecting the media in order of high media effect estimates for each budget allocation unit in every case of the number of executable media with a budget according to a media mixing method of the present invention (S109).

For example, it cannot be confirmed that the concentration of a total advertising budget on a portal site having the largest visitors ensures a better media effect than that of the case where the advertising budget is allocated to 5 media in high ranks. Thus, prior to allocation of the total advertising budget, it should be considered with every possibility how much advertising budget is allotted to which media in order to obtain the optimal media effect.

For example, assume that a total budget of $100,000 for advertisement campaigns can be allocated to sixty executable media by integer ratios of $5,000 in units of $5,000. In this case, a media mix capable of providing the highest media effect must be found out among various media mixes from a case where the total budget of $100,000 is allocated only to one medium to a case where the total budget of $100,000 is equally allocated to 20 media by $5,000 units.

The number of cases where the budget is allocated to one medium is 60, the number of cases where the budget is allocated to two media is 33,630, the number of cases where the budget is executed for three media is 5,851,620 and the number of cases where the budget is allocated to 20 media is 4,191,844,505,805,500. Accordingly, the total number of media mixes to which $100,000 can be allocated is 2,651,487,106,659,130,000 as calculated by the following Equation:

$${\sum }_{k = 1}^{20} {\sum }_{i = 1}^{k} {}_{60}^{}{C}{}_{i}^{} {X}_{k - 1} {C}_{k - i}$$

One method of searching a media mix which can provide the optimal media effect will be described hereinafter.

First, after determining a total advertising budget, every possible media mix is deduced in every case of the number of media to which the total advertising budget can be allocated. Then, media effect estimates of respective media mixes are sequentially obtained in such a way that media effect estimates of respective media in each media mix are deduced by substituting budget allocation units for the media effect estimation functions of the respective media of the media mix. Then, a media mix having a highest media effect estimate is selected among the total possible media mixes.

For example, assume that a total advertising budget of $15,000 is allocated in units of at least $5,000 to various media mixes of total 20 media. Then, a total number of possible media mixes can be obtained by summing up 20C1 which is the number of cases where the advertising budget is allocated to one medium, 20C2 which is the number of cases where the advertising budget is allocated to two media, and 20C3 which is the number of cases where the advertising budget is allocated to three media. Thus, the total number of possible media mixes is 2,680. Then, the media effect estimates of the respective media mixes are obtained by obtaining and summing up the media effect estimates of respective media for the respective media mixes, the total number of which is 2,680.

If the advertising budget is allocated to three media, $5,000 is equally allocated to A Company, B Company, and C Company. Media effect estimation functions of the respective media are y=0.0706x+167,615 for A Company, y=0.0397x+62,364 for B Company, and y=0.376x+193,678 for C Company. In this case, media effect estimates of A, B and C companies obtained by substituting $5,000 for the functions are A=0.0706×5,000+167,615, B=0.0397×5,000 +62,364, and C=0.376×5,000+193,678, respectively. The sum of these media effect estimates of the three media obtained by substituting the allocated budget becomes the media effect estimate of this media mix. In this way, the optimal media mix can be obtained by arranging the media effect estimates of the respective media mixes in order of high ranks, which are obtained by calculating the media effect estimates of the possible media mixes, a total number of which is 2,680.

However, when searching the optimal media mix by the method described above, there are some problems in terms of costs and time for calculation due to an excessive number of cases to be calculated. In particular, it can be appreciated from Table 3 that, as the number of media and the total advertising budget are increased, the number of possible media mixes is also increased in a geometric series. Thus, it is substantially impossible to realize a system which can deduce the optimal media mix by the method as described above. Table 3 shows the number of possible media mixes according to the total advertising budget if the number of media is sixty.

TABLE 3

| Budget | Media Mix Case Number |
|---|---|
| $5,000 | 60 |
| $10,000 | 1,830 |
| $15,000 | 37,820 |
| $20,000 | 595,656 |
| $25,000 | 7,624,512 |
| $30,000 | 82,598,880 |
| $35,000 | 778,789,440 |
| $40,000 | 6,522,361,560 |
| $45,000 | 49,280,065,120 |
| $50,000 | 340,032,449,328 |
| $55,000 | 2,163,842,859,360 |
| $60,000 | 12,802,736,917,880 |
| $65,000 | 70,907,466,006,720 |
| $70,000 | 369,731,787,035,040 |

A method of deducing an optimal media mix according to the present invention is based on a premise that it is ineffective to consider all possible media mixes for budget allocation in every case of the number of media executable with the advertising budget. The method of deducing the optimal media mix according to the present invention employs a method of preferentially selecting and mixing the media, each exhibiting the highest media effect estimate with the same budget allocation unit, in every case of the number of executable media within the total advertising budget (S109). Since the media effect estimation functions of the respective media are defined in the media effect estimation function deducing step (S107) in FIG. 1, it is possible to arrange the media effect estimates in high ranks for the same budget allocation unit. Therefore, if each of the media mixes consists of media, each of which suggests the highest media effect estimate for an associated budget allocation unit, the number of cases can be significantly reduced as shown in the following Table 4. Table 4 shows the number of media mixes for the total advertising budget according to the present invention.

TABLE 4

| Budget | Media Mix Case Number |
|---|---|
| $5,000 | 1 |
| $10,000 | 2 |
| $15,000 | 3 |
| $20,000 | 5 |
| $25,000 | 7 |
| $30,000 | 11 |
| $35,000 | 15 |
| $40,000 | 22 |
| $45,000 | 30 |
| $50,000 | 41 |
| $55,000 | 55 |
| $60,000 | 77 |
| $65,000 | 101 |
| $70,000 | 135 |

As in the above example, assuming again a total advertising budget of $15,000 is allocated in units of at least $5,000 to total 20 media, the total advertising budget of $15,000 can be allocated in budget units of three cases, that is, $5,000, $ 10,000, and $ 15,000. When substituting these budgets for associated media effect estimation functions of the twenty media, reach effect estimates of the respective media according to the budgets can be obtained as shown in Table 5.

TABLE 5

| Media | | | | | | |
|---|---|---|---|---|---|---|
| Budget | A | B | C | — | S | T |
| $5,000 | 649,936 | 528,441 | 668,990 | — | 449,521 | 331,278 |
| $10,000 | 1,023,578 | 1,249,889 | 875,021 | — | 730,112 | 694,582 |
| $15,000 | 1,495,330 | 1,660,316 | 1,204,761 | — | 921,004 | 997,094 |

If the total advertising budget is allocated to one medium Company, it is desirable that it be allocated to B Company, which suggests the highest value among media effect estimates which can be obtained with $ 15,000.

If the total advertising budget is allocated to two media companies, it is desirable that the total advertising budget be allocated to B and C companies, since B Company suggests the highest value among media effect estimates with $ 10,000, and C Company suggests the highest value among media effect estimates with $ 5,000. Then, the total media effect estimate of the media mix is obtained by summing up the media effect estimate of B Company with a budget allocation unit of $ 10,000 and the media effect estimate of C Company with a budget allocation unit of $5,000.

If the total advertising budget is allocated to three media companies, it is necessary to select three media companies to which the total advertising budget will be allocated by $ 5,000 units. In this case, since the media effect estimate is high in order of C Company, A Company and B Company, it is desirable to select these three media companies. The media effect estimate of this media mix is obtained by summing up the media effect estimates of C, A and B Companies to which the total budget of $ 15,000 is equally allocated by $ 5,000 units.

Table 6 shows total media effect estimates of the media mixes for these three cases described above (S111).

TABLE 6

| Media Mix Allocating Budget | Total Reach Effect Estimate |
|---|---|
| b($10,000) + c($5,000) | 1,918,879 |
| c($5,000) + a($5,000) + b($5,000) | 1,847,367 |
| b($15,000) | 1,660,316 |

As a result, the optimal reach effect can be expected when selecting a media mix of B and C in which the budget of $ 10,000 is allocated to B company, and the budget of $ 5,000 is allocated to C company. In other words, the method of deducing the optimal media mix according to the present invention is performed in the following manner: in the case where the budget is equally allocated to the respective media, after selecting the media in order of high media effect estimate in the media mix, media effect estimates of the selected media are summed up, and in the case where the budget is allocated in different amounts to the respective media, after selecting the media, each of which suggests the highest media effect estimate for an associated budget allocation unit, the media effect estimates of the selected media are summed up.

When media mixes and budget allocation units according to the present invention are classified in a matrix according to the number of executable media with a predetermined total advertising budget, a result as shown in Table 7 can be obtained (S113).

Table 7 shows the media mixes and budget allocation units according to the number of media when the total advertising budget is $ 40,000.

TABLE 7

| | Numbers | |
|---|---|---|
| Total | of Mixed | |
| Budget | Media | Media Mix Case |
| $40,000 | 1 | 40,000M1 |
| | 2 | 5,000M1 + 35,000M2 |
| | | 10,000M1 + 30,000M2 |
| | | 15,000M1 + 25,000M2 |
| | | 20,000M1 + 20,000M2 |
| | 3 | 5,000M1 + 5,000M2 + 30,000M3 |
| | | 5,000M1 + 10,000M2 + 25,000M3 |
| | | 5,000M1 + 15,000M2 + 20,000M3 |
| | | 10,000M1 + 10,000M2 + 20,000M3 |
| | | 10,000M1 + 15,000M2 + 15,000M3 |
| | 4 | 5,000M1 + 5,000M2 + 5,000M3 + 25,000M4 |
| | | 5,000M1 + 5,000M2 + 10,000M3 + 20,000M4 |
| | | 5,000M1 + 5,000M2 + 15,000M3 + 15,000M4 |
| | | 5,000M1 + 10,000M2 + 10,000M3 + 15,000M4 |
| | | 10,000M1 + 10,000M2 + 10,000M3 + 10,000M4 |
| | 5 | 5,000M1 + 5,000M2 + 5,000M3 + 5,000M4 + |
| | | 20,000M5 |
| | | 5,000M1 + 5,000M2 + 5,000M3 + 10,000M4 + |
| | | 15,000M5 |
| | | 5,000M1 + 5,000M2 + 10,000M3 + 10,000M4 + |
| | | 10,000M5 |
| | 6 | 5,000M1 + 5,000M2 + 5,000M3 + 5,000M4 + |
| | | 5,000M5 + 15,000M6 |
| | | 5,000M1 + 5,000M2 + 5,000M3 + 5,000M4 + |
| | | 10,000M5 + 10,000M6 |
| | 7 | 5,000M1 + 5,000M2 + 5,000M3 + 5,000M4 + |
| | | 5,000M5 + 5,000M6 + 10,000M7 |
| | 8 | 5,000M1 + 5,000M2 + 5,000M3 + 5,000M4 + |
| | | 5,000M5 + 5,000M6 + 5,000M7 + 5,000M8 |

In Table 7, media are indicated by M1, M2, M3, M4, and the like in order of high media effect estimates when a budget allocation unit is substituted for media effect estimation functions of the media in each media mix.

For example, for a total advertising budget of $ 40,000, “40,000M1” means selection of M1 which suggests the highest value among media effect estimates obtained when substituting $ 40,000 for the media effect estimation functions of the media. “5,000M1+5,000M2+30,000M3” means selection of M1, M2 and M3, in which M1 and M2 respectively suggest the highest value and the second value among media effect estimates obtained when substituting a budget of $ 5,000 for the media effect estimation functions of the media, and M3 suggests the highest value among media effect estimates obtained when substituting a budget of $ 30,000 for the media effect estimation functions of the media.

If one of the media is selected once along with a budget allocation unit therefor, the selected medium is precluded from being selected for other budget allocations. Specifically, if one of the media suggests the highest media effect estimate with various budget allocation units, the medium is included in a media mix in which the medium is provided with the highest budget allocation unit. For example, in the case where both media corresponding to 5,000M1 and 30,000M3 are the same medium, for example, A Company, the A Company is selected only for 30,000M3 which means that a higher budget is allocated to the A Company than the case of 5,000M1. Thus, B Company is selected for 5,000M1, and C Company is selected for 5,000M2 since C Company is next to B company in view of media effect estimates for a budget of $ 5,000.

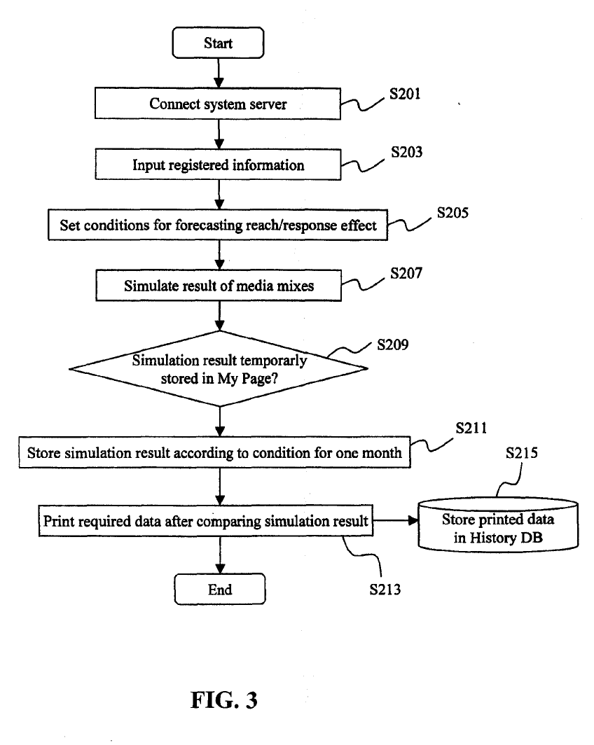

FIG. 3 is a block diagram illustrating operation of an advertising budget allocation system according to the present invention.

After connecting to an advertising budget allocation system server via a client computer by inputting authorized ID/Password (S201), a user inputs his or her registered user information and advertising campaign information (S203). After selecting whether a media effect of advertising should be forecasted in terms of reach effect or in terms of response effect, the user sets conditions for forecasting the media effect, such as a total budget for advertisement campaign, precluding media, and the like (S205). Then, the system performs simulation for providing a media mix, and suggests results of the simulation in order of high ranks in terms of the media effect (S207). When temporarily storing the results of the simulation in a “My Page” which is assigned to the user (S209), the results of the simulation are automatically stored therein for one month, and can be verified by the user for that period (S211).

If the user prints the stored results (S213), the system determines that the stored results are acknowledged as final reports, and stores the printed results in a history database of the system (S215).

Every result of the simulation stored in the history database of the system can be shared with all authorized users. Accordingly, if similar conditions are set by other users, the other users can be rapidly supplied with useful information of a media mix through information retrieval of similar cases without simulation of the media mix according to these conditions.

As apparent from the above description, the present invention can easily deduce a media mix which optimizes media effects of advertisement campaign, thereby providing advantageous effects of maximizing ROI of a client while enhancing reliability on online banner advertisement market.

It will be apparent to those skilled in the art that the method for allocating advertising budget to media in online advertising according to the present invention can be automatically performed by a computer system, and that a program to allow execution of the method can be stored in a computer-readable recording medium.

It should be understood that the embodiments and the accompanying drawings have been described for illustrative purposes and the present invention is limited only by the following claims. Further, those skilled in the art will appreciate that various modifications, additions and substitutions are allowed without departing from the scope and spirit of the invention as set forth in the accompanying claims.

What is claimed is:

1. A method for allocating advertising budget to media in online advertising, comprising the steps of:
deducing media effect estimation functions of the respective media;
calculating media effect estimates of the respective media according to budget allocation units from the media effect estimation functions;
selecting the media in order of high media effect estimates with the respective budget allocation units in every case of the number of media desired to be executed with a budget by using the calculated media effect estimates of the media, followed by mixing the selected media to provide media mixes;
summing up the total media effect estimates of the selected media for the respective media mixes obtained in the media selecting and mixing step; and
selecting and suggesting a media mix providing a maximum summed-up media effect estimate among the summed-up media effect estimates obtained by the summing-up step.

2. The method according to claim 1, wherein said media effect is a response effect.

3. The method according to claim 1, wherein said media effect is a reach effect.

4. The method according to claim 1, further comprising:
selecting and suggesting the media mixes in order of high summed-up media effect estimates.

5. The method according to claim 1, wherein said media effect estimation functions are deduced from a result obtained through filtering and extracting of analysis items with respect to a database of existing advertising results.

6. The method according to claim 5, wherein, if said media effect is a reach effect, the analysis items comprise items of media, budget, impression and the number of unique viewers, and if said media effect is a response effect, the analysis items comprise items of media, budget, impression and the number of clicks.

7. The method according to claim 1, wherein, if one of the media is selected for one budget allocation unit in selection of the media mix, the selected medium is precluded in selection for other budget allocation units.

8. A system of allocating advertising budget to media in online advertising, comprising:
a means for deducing media effect estimation functions of the respective media;
a means for calculating media effect estimates of the respective media according to budget allocation units from the media effect estimation functions;
a means for selecting the media in order of high media effect estimates with the respective budget allocation units in every case of the number of media desired to be executed with a budget by using the calculated media effect estimates of the media, and for mixing the selected media to provide media mixes;
a means for summing up the total media effect estimates of the selected media for the respective media mixes; and
a means for selecting and suggesting a media mix providing a maximum summed-up media effect estimate among the summed-up media effect estimates.

9. The system according to claim 8, wherein said media effect is a response effect.

10. The system according to claim 8, wherein said media effect is a reach effect.

11. The system according to claim 8, wherein the media mixes are selected and suggested in order of high summed-up media effect estimates.

12. The system according to claim 8, wherein, if one of the media is selected for one budget allocation unit in selection of the media mix, the selected medium is precluded in selection for other budget allocation units.
